(19) United States
(12) Patent Application Publication
(10) Pub. No.: US 2024/0152227 A1
(43) Pub. Date: May 9, 2024

(54) USER INTERFACE CONTROLS SELECTIONS

(71) Applicant: Hewlett-Packard Development Company, L.P., Spring, TX (US)

(72) Inventor: Shinoj BHASKARAN, Bangalore (IN)

(21) Appl. No.: 18/275,327

(22) PCT Filed: Aug. 26, 2021
(86) PCT No.: PCT/US2021/071291

§ 371 Date: Aug. 1, 2023

(30) Foreign Application Priority Data
Feb. 3, 2021 (IN) 202141004601

(51) Int. Cl. G06F 3/041; H04N 1/00

(52) U.S. Cl. CPC G06F 3/04162; H04N 1/00204

(57) ABSTRACT

In an example, a non-transitory computer-readable storage medium encoded with instructions that, when executed by a processor of a first electronic device, cause the processor to receive a request to execute an application that enables communication with a second electronic device. Further, the processor may cause a camera to output a view of a user interface of the second electronic device on a display panel via executing the application. Furthermore, the processor may receive a touch input to select a control associated with the user interface via the display panel and determine input data corresponding to the touch input. Further, the processor may transmit the input data to the second electronic device to perform an action on the second electronic device.

### BACKGROUND

An electronic device such as an image forming apparatus may include a user interface (e.g., a control panel) that permits a user to operate or otherwise control multiple functions (e.g., printing, scanning, faxing, providing access to a network (e.g., for email services), setting information, and the like) of the image forming apparatus. The user interface may include multiple user-selectable controls such as a physical control, a touch control, a graphical user interface (e.g., a touch screen display panel), and/or any combination thereof. Further, the user interface may display a menu of features or settings that can be selected or deselected. The user-selectable controls may include alphanumeric keys, directional arrow keys, switch buttons, and/or the like to navigate the menu on the user interface and operate the image forming apparatus. Such electronic devices may be shared by multiple users, for instance, in an enterprise environment.

### BRIEF DESCRIPTION OF THE DRAWINGS

Examples are described in the following detailed description and in reference to the drawings, in which:

FIG. 1 is a block diagram of an example first electronic device including a non-transitory machine-readable storage medium storing instructions to transmit input data to perform an action on a second electronic device;

FIG. 2 is a block diagram of an example first electronic device, including an application to determine coordinate information to control a user interface of a second electronic device;

FIG. 3A depicts a schematic diagram of the example first electronic device of FIG. 2, displaying a view of the user interface of the second electronic device;

FIG. 3B depicts a schematic diagram of the example first electronic device of FIGS. 2 and 3A, illustrating a detected boundary of the user interface via changing a focus of a camera;

FIG. 3C depicts a schematic diagram of the example first electronic device of FIGS. 2 and 3B, illustrating coordinate information corresponding to a touch input based on the detected boundary;

FIG. 4A depicts a schematic diagram of the example first electronic device of FIG. 2, displaying a view of the user interface of the second electronic device;

FIG. 4B depicts a schematic diagram of the example first electronic device of FIG. 4A, illustrating text information corresponding to the touch input;

FIG. 5 is a block diagram of an example image forming apparatus including a non-transitory machine-readable storage medium storing instructions to perform an action based on a touch input detected via a touch panel of an external electronic device; and

FIG. 6 depicts a schematic diagram of an example system including an image forming apparatus and an external electronic device to control the image forming apparatus.

### DETAILED DESCRIPTION

In an enterprise environment, electronic devices such as image forming apparatuses (e.g., printers) may be shared by multiple users. Such electronic devices may include user interfaces (e.g., control panels) through which the users can operate or control functions of the electronic devices. For example, an image forming apparatus may include a function such as a print, scan, fax, provide access to a network (e.g., for email services), and/or the like. Further, to operate the image forming apparatus or control the functions, the user interface may be provided with multiple user-selectable controls such as physical control, touch controls, a graphical user interface (e.g., a touch screen display panel), and/or any combination thereof. In some examples, the user interface may include a display panel (e.g., a liquid crystal display, an organic electro luminescence (EL) display, or the like) depicting menu items and/or settings that can be changed/selected via the user-selectable controls on the user interface. For example, a scan control may start a scan operation with the settings on the display panel selected via the user-selectable controls, a stop control may cancel the scan operation or the settings on the display panel, up/down arrow controls may move a cursor on the display panel or increase and decrease numbers being entered, or the like.

When multiple users use such electronic devices, a surface of the user interface may be prone to contamination (e.g., with germs, dirt, virus, and/or the like). Further, such surfaces may be a mode of transmission of spreadable viruses from one user to another user as the viruses can stay active for significantly longer time on such surfaces (e.g., which are made up of a glass, plastic, rubber, and/or the like). Thus, the users may be cautious about using such shared electronic devices.

Some example image forming apparatuses may provide a remote view of a front panel or a control panel, through an embedded web server. However, the remote view may reflect a static or inactive view of the front panel such as a screen shot of the front panel as seen by the user at the image forming apparatus. However, the remote user cannot use the functions provided by the front panel, neither can the remote user traverse the different menus provided on the front panel.

Some other example image forming apparatuses may include an embedded web server connected to a remote user interface via a network. The remote user interface may interact with the embedded web server to provide a remote-control panel, which may be, for example, an active web page in a web browser. By interacting with the remote-control panel, the user may be able to traverse the menus of the front panel and make a selection to cause the image forming apparatus to perform the corresponding operation. Changes made by the user via the remote-control panel may be reflected by a front panel of the image forming apparatus. However, such remote-control panels may involve the remote user logging into the embedded web server by typing a uniform resource locator (URL) in the web browser. Further, such remote-control panel applications may be specific to a type of the image forming apparatus. Also, the look and feel of the remote-control panel in the application can be different from an actual view of the control panel of the image forming apparatus, which can affect the user experience.

Examples described herein may provide a first electronic device (e.g., a smart phone) that executes an application to capture a view of a user interface of a second electronic device (e.g., an image forming apparatus) and reflect touch inputs corresponding to the captured view to the user interface of the image forming apparatus. The first electronic device may include a camera and a display panel. During operation, the first electronic device may cause the camera to output the view of the user interface on the display panel. Further, the first electronic device may receive a touch input to select a control associated with the user interface via the display panel. Upon receiving the touch input, the first electronic device may determine input data (e.g., coordinate information or text information) corresponding to the touch input and transmit the input data to the second electronic device to perform an action on the second electronic device.

In an example, when the input data includes coordinate information, the second electronic device may determine a location on the user interface that is proportional to the received coordinate information. Further, the second electronic device may determine a user-selectable control that is being displayed on the determined location on the user interface to perform the corresponding action.

In another example, when the input data includes text information, the second electronic device may compare the text information with a set of user-selectable controls that are being displayed on the user interface. Further, the second electronic device may determine the user-selectable control from the set of user-selectable controls based on the comparison to perform the corresponding action. Thus, examples described herein may enable the first electronic device to simulate user inputs using coordinate or text information to communicate with the second electronic device such as the image forming apparatus.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

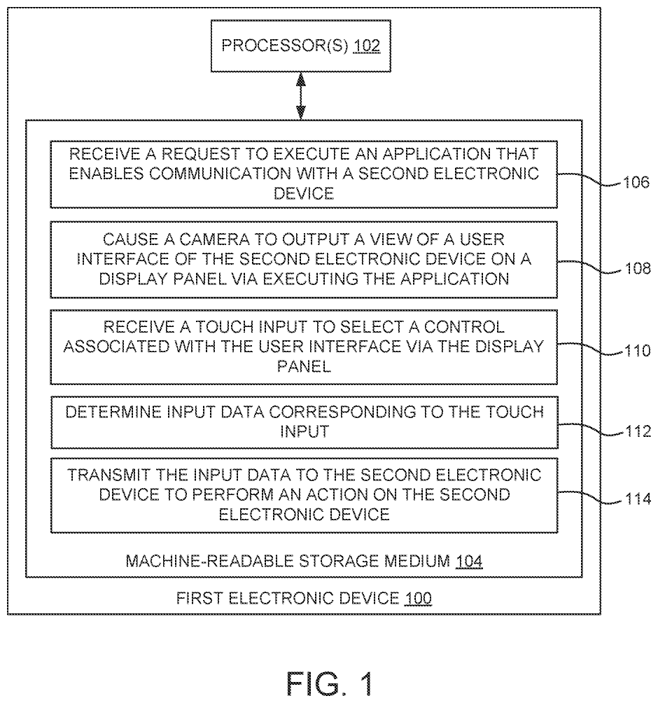

Turning now to the figures, FIG. 1 is a block diagram of an example first electronic device 100 including a non-transitory machine-readable storage medium 104 storing instructions to transmit input data to perform an action on a second electronic device. For example, first electronic device 100 may be a smart phone, a tablet computer, a personal digital assistant, or any handheld device having a built-in camera. The second electronic device can be an image forming apparatus (e.g., a printer, a scanner, a fax machine, a multifunction peripheral, or the like) or any electronic device that includes a user interface (e.g., a control panel). Example first electronic device 100 may include a processor 102 and machine-readable storage medium 104 communicatively coupled through a system bus. Processor 102 may be any type of central processing unit (CPU), microprocessor, or processing logic that interprets and executes machine-readable instructions stored in machine-readable storage medium 104.

Machine-readable storage medium 104 may be a random-access memory (RAM) or another type of dynamic storage device that may store information and machine-readable instructions that may be executed by processor 102. For example, machine-readable storage medium 104 may be synchronous DRAM (SDRAM), double data rate (DDR), rambus DRAM (RDRAM), iambus RAM, etc., or storage memory media such as a floppy disk, a hard disk, a CD-ROM, a DVD, a pen drive, and the like. In an example, machine-readable storage medium 104 may be non-transitory machine-readable medium. Machine-readable storage medium 104 may be remote but accessible to first electronic device 100.

As shown in FIG. 1, machine-readable storage medium 104 may store instructions 106-114. In an example, instructions 106-114 may be executed by processor 102 to transmit input data to perform an action on the second electronic device. Instructions 106 may be executed by processor 102 to receive a request to execute an application that enables communication with the second electronic device. In an example, the application may be installed in first electronic device 100. Further, the application may be executed when a user selects an icon (e.g., by clicking on the icon) corresponding to the application in first electronic device 100. In another example, the application may be accessed via a web browser.

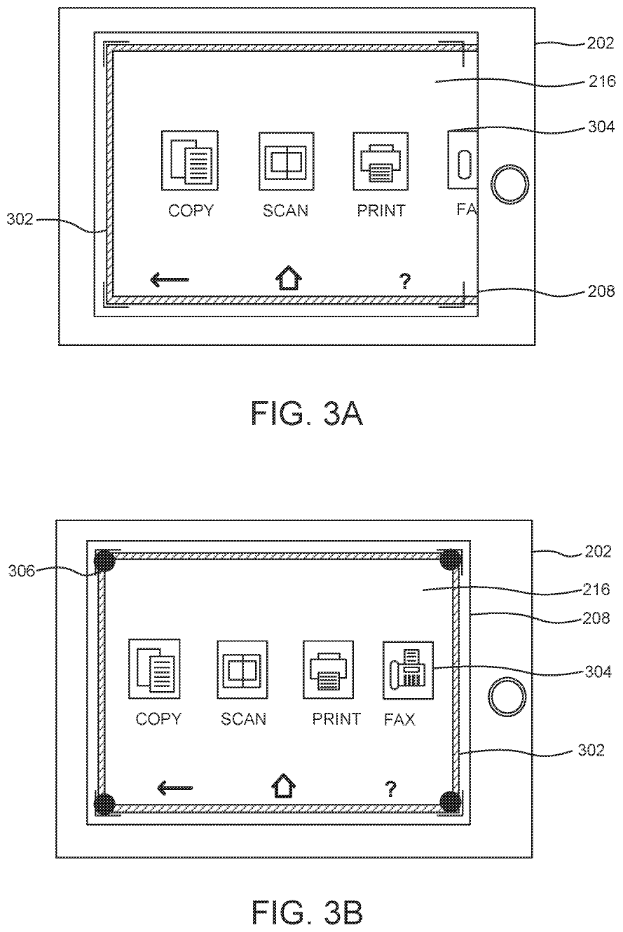

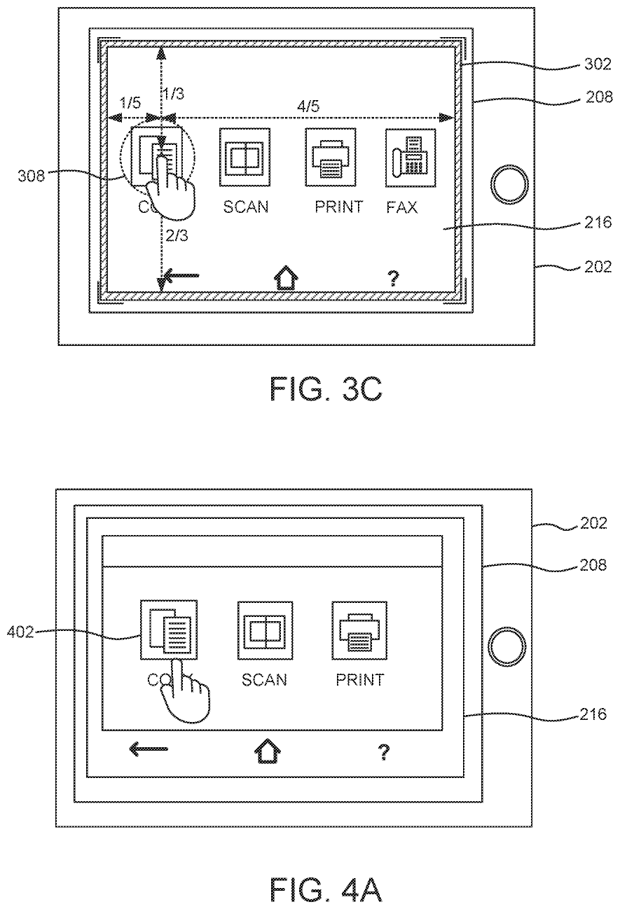

Instructions 108 may be executed by processor 102 to cause a camera to output a view of a user interface of the second electronic device on a display panel via executing the application. In an example, when the application is executed/activated by positioning first electronic device 100 above the second electronic device in such a way to focus the user interface of the second electronic device, the application may access the camera, which may be in-built in first electronic device 100, to output the view of the user interface on the display panel. An example display panel displaying the view of the user interface is depicted in FIGS. 3A and 4A.

Instructions 110 may be executed by processor 102 to receive a touch input to select a control associated with the user interface via the display panel. For example, the user interface may include a user-selectable control such as a physical control (e.g., a physical button), a touch control (e.g., a touch button), a graphical user interface (e.g., a touch screen display panel), and/or the like. In an example, when the display panel displays the user interface, the user may be able to select or deselect the control provided on the user interface by touching the display panel Thus, the user may be able to provide the touch input to select the control on the user interface of the second electronic device without actually touching the user interface. An example display panel depicting the touch input is shown in FIGS. 3C and 4A.

Instructions 112 may be executed by processor 102 to determine input data corresponding to the touch input. In an example, instructions 112 to determine the input data corresponding to the touch input may include instructions to determine coordinate information that correspond to a position of the touch input on the display panel with respect to a boundary of the user interface. Example boundary may be a rectangle that surrounds the user interface. In this example, the touch point on the display panel may correspond to a set of coordinates (e.g., X-coordinate for a left/right rectangle edge, Y-coordinate for a top/bottom rectangle edge). When the user touches the display panel, information about coordinates of the touch point with respect to at least two adjacent sides/edges of the boundary may be determined. An example detection of the coordinate information is described in FIG. 30.

In another example, instructions to determine the input data corresponding to the touch input may include instructions to capture a portion of the user interface substantially around the touch input and extract text information corresponding to the touch input via processing the captured portion of the user interface. An example determination of the input data by capturing the portion of the user interface is shown in FIG. 4B.

Instructions 114 may be executed by processor 102 to transmit the input data to the second electronic device to perform an action on the second electronic device. In an example, instructions to transmit the input data to the second electronic device may include instructions to transmit the input data to the second electronic device via a short-range wireless connection. An example short-range wireless connection can include Bluetooth, radio frequency identification (RFID), infrared data association (IrDA), ultra-wideband (UWB), ZigBee, near-field communication (NFC), wireless-fidelity (VVi-Fi), Wi-Fi Direct, wireless universal serial bus (USB), or the like. Upon receiving the input data, the second electronic device may determine a user-selectable control that corresponds to the input data from multiple user-selectable controls that are being displayed on the user interface. Further, the second electronic device may perform an action (e.g., an execution of scan job, a change in setting data, a selection of a menu item, or the like) associated with the user-selectable control. Thus, changes made by the user via the display panel (e.g., the captured view of the user interface) may be reflected by the user interface of the image forming apparatus.

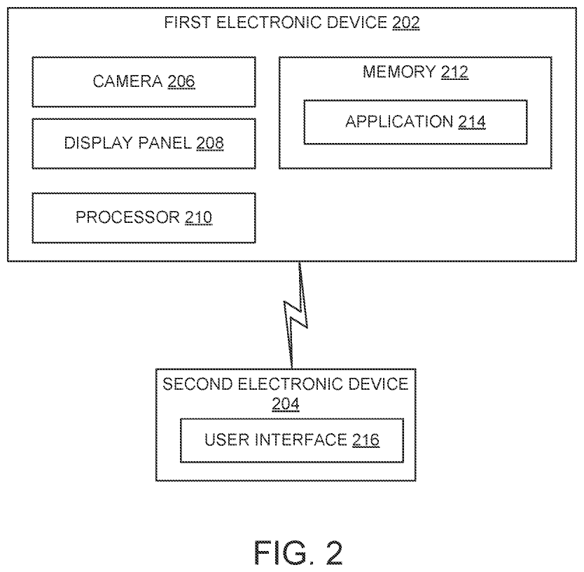

FIG. 2 is a block diagram of an example first electronic device 202, including an application 214 to determine coordinate information to control a user interface 216 of a second electronic device 204. For example, first electronic device 202 may be a handheld device such as a smart phone. Second electronic device 204 may be a device having a control panel (e.g., a user interface 216) which provides an interface to users to operate or control an operation on the device such as an image forming apparatus. An example image forming apparatus may be a single function peripheral (SFP) or a multi-function peripheral (MFP).

As shown in FIG. 2, first electronic device 202 may include a camera 206 (e.g., an in-built camera) positioned to have a view of user interface 216 of second electronic device 204. Further, first electronic device 202 may include a display panel 208. For example, display panel 208 may include an input or touch screen that can receive a touch input by a user. An example touch screen may be an infrared touch panel, a capacitive touch panel, a pressure-sensitive touch panel, or the like. Furthermore, first electronic device 202 may include a processor 210 to execute an application 214 stored in a memory 212. Processor 210 may be a type of central processing unit (CPU), microprocessor, or processing logic that interprets and executes machine-readable instructions stored in machine-readable storage medium or memory 212 in first electronic device 202.

During operation, processor 210 may cause camera 206 to output the view of user interface 216 on display panel 208. Further, processor 210 may detect a boundary associated with user interface 216. In an example, processor 210 may detect the boundary associated with user interface 216 based on an identification marker provided on second electronic device 204. In such examples, processor 210 may enable to change a focus of camera 206 (e.g., via changing the position of first electronic device 202) until the boundary associated with user interface 216 is detected. An example to change the focus of camera 206 to detect the boundary is described with respect to FIGS. 3A and 3B.

Further, processor 210 may receive a touch input to select a control associated with user interface 216 via display panel 208 in response to the detection of the boundary. Furthermore, processor 210 may determine coordinate information that corresponds to a position of the touch input on display panel 208 relative to the boundary. For example, the coordinate information includes information about the position of the touch input corresponding to at least two sides of the boundary, which in turn represent actual coordinates of user interface 216. An example determination of the coordinate information is depicted in FIG. 3C, In other examples, processor 210 may determine skew corrected coordinate information that corresponds to the position of the touch input on display panel 208, for instance, when camera 206 is held in a tilted orientation.

Furthermore, processor 210 may transmit the coordinate information to second electronic device 204 to control user interface 216 of second electronic device 204. In an example, processor 210 may transmit the coordinate information to second electronic device 204 via a short-range wireless connection such as Bluetooth, radio frequency identification (RFID), infrared data association (IrDA), ultra-wideband (UWB), ZigBee, near-field communication (NFC), wireless-fidelity (Wi-Fi), Wi-Fi Direct, wireless universal serial bus (USB), or the like. Upon receiving the coordinate information, second electronic device 204 may determine a location on user interface 216 that is proportional to the received coordinate information. Further, second electronic device 204 may determine a user-selectable control that is being displayed on the user interface corresponding to the determined location. Further, the second electronic device may activate the determined user-selectable control to perform a corresponding action (e.g., an execution of scan job, a change in setting data, a selection of a menu item, or the like).

In some examples, the functionalities described herein, in relation to instructions to implement functions of application 214 and any additional instructions described herein in relation to the storage medium, may be implemented as engines or modules including any combination of hardware and programming to implement the functionalities of the modules or engines described herein. The functions of application 214 may also be implemented by a processor. In examples described herein, processor may include, for example, one processor or multiple processors included in a single device or distributed across multiple devices.

FIG. 3A depicts a schematic diagram of example first electronic device 202 of FIG. 2, displaying a view of user interface 216 of a second electronic device (e.g., second electronic device 204 of FIG. 2). Similarly named elements of FIG. 3A may be similar in function and/or structure to elements described in FIG. 2. As shown in FIG. 3A, when a camera of first electronic device 202 captures a view of user interface 216, first electronic device 202 may attempt to detect a boundary 302 of user interface 216. For example, first electronic device 202 may use an image detection algorithm to detect identification markers disposed substantially around user interface 216 of the second electronic device. The identification markers may enable first electronic device 202 to detect boundary 302. In the example shown in FIG. 3A, first electronic device 202 may not be able to detect boundary 302 as the camera is not focused to view entire user interface 216 (e.g., a control 304 (e.g., a fax) is not visible within display panel 208).

Further, the user can change the focus of the camera until entire boundary 302 is detected as shown in FIG. 3B. For example, as shown in FIG. 3B, control 304 is visible due to the change in the focus of the camera. Thus, the user may focus the camera in order to capture boundary 302 of user interface 216. In response to detecting boundary 302, first electronic device 202 may display an indication 306 that indicates that boundary 302 is detected. For example, boundary 302 may be rectangular in shape as shown in FIG. 3B. In other examples, boundary 302 may be of any other geometrical shape such as a square or circle depending on a shape of user interface 216 of the second electronic device.

FIG. 3C depicts a schematic diagram of example first electronic device 202 of FIGS. 2 and 3B, illustrating coordinate information corresponding to a touch input 308 based on detected boundary 302. Similarly named elements of FIG. 3C may be similar in function and/or structure to elements described in FIGS. 2 and 3B. In an example, when touch input 308 is received, first electronic device 202 may determine the coordinate information corresponding to tough input 308. For example, the coordinate information may indicate a distance of a center of touch point 308 from the sides of boundary 302. As shown in FIG. 30, the coordinate information depicts that the center of touch point 308 is one fifth of the breadth from a left side of boundary 302, four fifth of the breadth from a right side of boundary 302, one third of the height from a top side of boundary 302, and two third of the height from a bottom side of boundary 302. Further, the determined coordinate information may be transmitted to the second electronic device to perform a corresponding action. In an example, the second electronic device may determine that a copy function as being selected based on the received coordinate information and perform the copy function. Thus, examples described herein may be independent of any change in size, resolution, and/or the like of user interface 216 because the coordinates are shared proportional to the breadth and height of user interface 216 with respect to boundary 302.

FIG. 4A depicts a schematic diagram of example first electronic device 202 of FIG. 2, displaying a view of user interface 216 of a second electronic device (e.g., second electronic device 204 of FIG. 2). Similarly named elements of FIG. 4A may be similar in function and/or structure to elements described in FIG. 2. As shown in FIG. 4A, a camera of first electronic device 202 may capture a view of at least a portion of user interface 216. Further, display panel 208 may display the portion of user interface 216 as viewed by the camera. For example, display panel 208 may display the portion of user interface 216 to select or deselect controls provided on the portion of user interface 216. Further, first electronic device 202 may receive a touch input to select a control (e.g., a “copy” control 402) on display panel 208.

Upon receiving the touch input, first electronic device 202 may determine input data corresponding to the touch input as follows. First, a portion 404 of user interface 216 around the touch input may be captured as shown in FIG. 4B. Further, text information (e.g., “copy”) corresponding to the touch input may be extracted from captured portion by processing captured portion 404 (i.e., captured image), for instance, using an optical character recognition (OCR) based method. Further, text information “copy” may be transmitted to second electronic device 204 via the short-range wireless connection to perform a corresponding action (e.g., to perform a “copy” function).

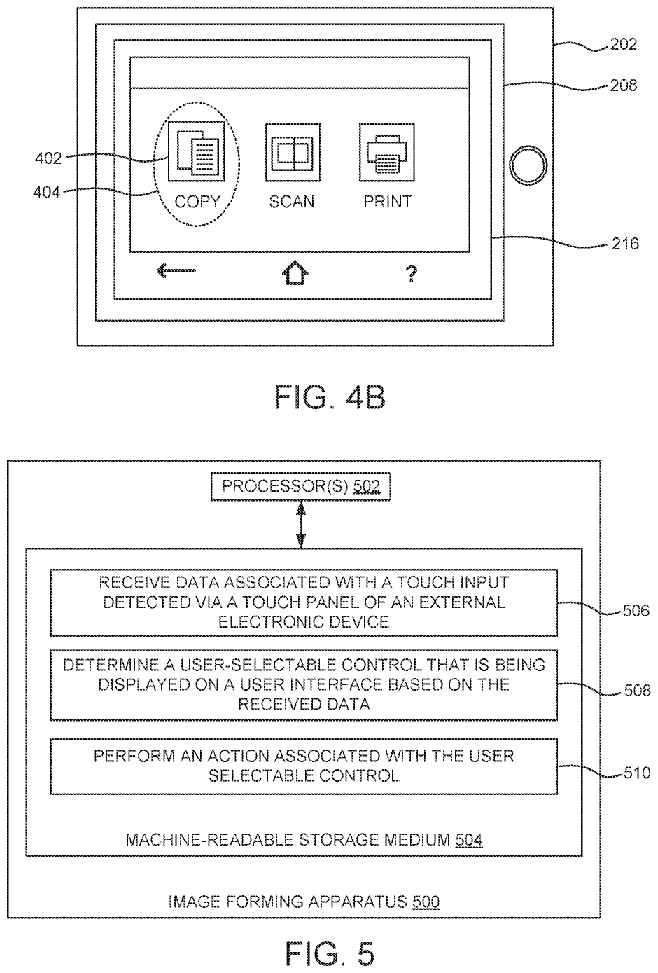

FIG. 5 is a block diagram of an example image forming apparatus 500 including a non-transitory machine-readable storage medium 504 storing instructions to perform an action based on a touch input detected via a touch panel of an external electronic device. As used herein, the term “image forming apparatus” may refer to a device that may encompass any apparatus that accepts a job-request and performs at least one of the following functions or tasks: print, scan, copy, and/or fax. Image forming apparatus 500 may be a single function peripheral (SFP) or a multi-function peripheral (MFP). Example image forming apparatus 500 can be a laser beam printer (e.g., using an electrophotographic method for printing), an ink jet printer (e.g., using an ink jet method for printing), or the like.

Image forming apparatus 500 may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), rambus DRAM (RDRAM), iambus RAM, etc., or storage memory media such as a floppy disk, a hard disk, a CD-ROM, a DVD, a pen drive, and the like. In an example, machine-readable storage medium 504 may be non-transitory machine-readable medium. Machine-readable storage medium 504 may be remote but accessible to image forming apparatus 500.

As shown in FIG. 5, machine-readable storage medium 504 may store instructions 506-510. In an example, instructions 506-510 may be executed by processor 502 to perform an action based on a received touch input. Instructions 506 may be executed by processor 502 to receive data (e.g., input data) associated with a touch input detected via a touch panel of an external electronic device. In an example, instructions to receive the data associated with the touch input may include instructions to receive the data including coordinate information of the touch input detected by the touch panel of the external electronic device. In another example, instructions to receive the data associated with the touch input may include instructions to receive the data including text information corresponding to the touch input detected by the touch panel of the external electronic device.

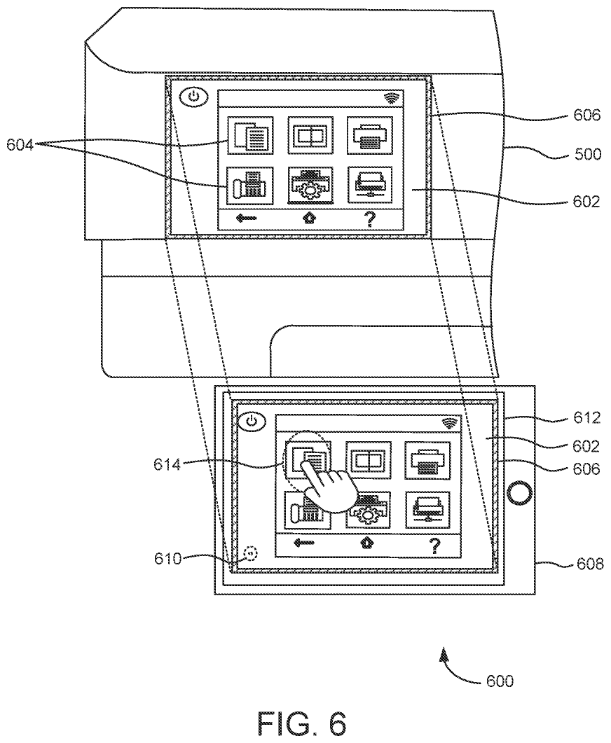

Instructions 508 may be executed by processor 502 to determine a user-selectable control that is being displayed on a user interface based on the received data. When the data includes coordinate information of the touch input, instructions 508 to determine the user-selectable control may include instructions to determine a location on the user interface that is proportional to the received coordinate information. The location on the user interface may be determined with respect to an identification marker provided substantially around the user interface of image forming apparatus 500. Further, instructions may determine the user-selectable control that is being displayed on the determined location on the user interface. An example determination of the user-selectable control using the coordinate information is depicted in FIG. 6.

When the data includes text information corresponding to the touch input, instructions 508 to determine the user-selectable control may include instructions to compare the text information with a set of user-selectable controls that are being displayed on the user interface. Further, instructions may determine the user-selectable control from the set of user-selectable controls based on the comparison. For example, when image forming apparatus 500 receives text information as “copy”, processor 502 may match “copy” to texts of user-selectable controls that are currently being displayed on the user interface. Further, processor 502 may determine the user-selectable control as “copy” operation. Instructions 510 may be executed by processor 502 to perform an action associated with the user-selectable control. In the above example, processor 502 may perform the “copy” operation. Thus, examples described herein may enable image forming apparatus 500 to receive the input data such as coordinate information or text information from the external device, and perform a corresponding action, for instance, navigating through a menu on a display panel of the user interface, changing/selecting setting information, and/or performing functions such a print, copy, scan, fax, or the like.

FIG. 6 depicts a schematic diagram of an example system 600 including an image forming apparatus 500 (e.g., as shown in FIG. 5) and an example external electronic device 608 to control image forming apparatus 500. Similarly named elements of FIG. 6 may be similar in function and/or structure to elements described in FIG. 5. As shown in FIG. 6, image forming apparatus 500 may include a user interface 602 having a plurality of user-selectable controls (e.g., 604). Further, image forming apparatus 500 may include an identification marker 606 provided on image forming apparatus 500.

Further, system 600 may include external electronic device 608 (e.g., a smart phone) having a camera 610 and a touch panel 612 (e.g., a touch screen display panel). During operation, external electronic device 608 may execute an application to communicate and control user interface 602 of image forming apparatus 500. Further, the execution of the application may turn-on camera 610 to cause camera 610 to capture a view of user interface 602 and display the view on touch panel 612 of external electronic device 608. Further, external electronic device 608 may detect a boundary associated with user interface 602 based on identification marker 606 and determine coordinate information corresponding to a touch input 614 on touch panel 612 with respect to the detected boundary. Then, external electronic device 608 may transmit the coordinate information that corresponds to touch input 614 to image forming apparatus 500, for instance, via a short-range wireless communication.

Furthermore, image forming apparatus 500 may receive the coordinate information and determine a location on user interface 602 that is proportional to the received coordinate information with respect to identification marker 606. Further, image forming apparatus 500 may determine the user-selectable control that is being displayed on the determined location on the user interface. Further, image forming apparatus 500 may perform an action associated with the determined user-selectable control.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

1. A non-transitory computer-readable storage medium encoded with instructions that, when executed by a processor of a first electronic device, cause the processor to:
receive a request to execute an application that enables communication with a second electronic device;
cause a camera to capture a view of a user interface of the second electronic device to display the user interface on a display panel of the first electronic device via executing the application;
receive a touch input to select a control associated with the user interface via the display panel;
determine input data corresponding to the touch input; and
transmit the input data to the second electronic device to perform an action on the second electronic device.

2. The non-transitory computer-readable storage medium of claim 1,
wherein instructions to determine the input data corresponding to the touch input comprise instructions to:
determine coordinate information that corresponds to a position of the touch input on the display panel with respect to a boundary of the user interface.

3. The non-transitory computer-readable storage medium of claim 1, wherein instructions to determine the input data corresponding to the touch input comprise instructions to:
capture a portion of the user interface substantially around the touch input; and
extract text information corresponding to the touch input via processing the captured portion of the user interface.

4. The non-transitory computer-readable storage medium of claim 1, wherein instructions to transmit the input data to the second electronic device comprise instructions to: transmit the input data to the second electronic device via a short-range wireless connection.

5. A first electronic device comprising:
a camera positioned to capture a view of a user interface of a second electronic device;
a display panel; and
a processor to execute an application to:
output the view of the user interface on the display panel;
detect a boundary associated with the user interface;
receive a touch input to select a control associated with the user interface via the display panel in response to the detection of the boundary;
determine coordinate information that corresponds to a position of the touch input on the display panel relative to the boundary; and
transmit the coordinate information to the second electronic device to control the user interface of the second electronic device.

6. The first electronic device of claim 5, wherein the processor is to:
detect the boundary associated with the user interface based on an identification marker provided on the second electronic device.

7. The first electronic device of claim 5, wherein the processor is to:
transmit the coordinate information to the second electronic device via a short-range wireless connection.

8. The first electronic device of claim 5, wherein the processor is to:
determine skew corrected coordinate information that corresponds to the position of the touch input on the display panel.

9. The first electronic device of claim 5, wherein the processor is to:
enable to change a focus of the camera until the boundary associated with the user interface is detected.

10. A non-transitory computer-readable storage medium encoded with instructions that, when executed by a processor of an image forming apparatus, cause the processor to:
receive data associated with a touch input detected via a touch panel of an external electronic device;
determine a user-selectable control that is being displayed on a user interface based on the received data; and
perform an action associated with the user-selectable control.

11. The non-transitory computer-readable storage medium of claim 10, wherein instructions to receive the data associated with the touch input comprise instructions to:
receive the data including coordinate information of the touch input detected by the touch panel of the external electronic device.

12. The non-transitory computer-readable storage medium of claim 11, wherein instructions to determine the user-selectable control comprise instructions to:
determine a location on the user interface that is proportional to the received coordinate information with respect to an identification marker; and
determine the user-selectable control that is being displayed on the determined location on the user interface.

13. The non-transitory computer-readable storage medium of claim 10, wherein instructions to receive the data associated with the touch input comprise instructions to:
receive the data including text information corresponding to the touch input detected by the touch panel of the external electronic device.

14. The non-transitory computer-readable storage medium of claim 13, wherein instructions to determine the user-selectable control comprises:
compare the text information with a set of user-selectable controls that are being displayed on the user interface; and
determine the user-selectable control from the set of user-selectable controls based on the comparison.

15. The non-transitory computer-readable storage medium of claim 10, wherein the user interface comprises a physical control, a touch control, a graphical user interface, or a combination thereof.
